(19) United States
(12) Patent Application Publication
(10) Pub. No.: US 2025/0387763 A1
(43) Pub. Date: Dec. 25, 2025

(54) AIR BUBBLE FORMING DEVICE, AIR BUBBLE FORMING METHOD, EVALUATION DEVICE, AND EVALUATION METHOD

(71) Applicant: Kagoshima University, Kagoshima (JP)

(72) Inventor: Takashi GOSHIMA, Kagoshima (JP)

(21) Appl. No.: 18/881,130

(22) PCT Filed: Jul. 3, 2023
(86) PCT No.: PCT/JP2023/024592

§ 371 Date: Jan. 3, 2025

(30) Foreign Application Priority Data
Jul. 4, 2022 (JP) 2022-107754

(51) Int. Cl. B01F 23/2373; B01F 35/214

(52) U.S. Cl. CPC B01F 23/2373; B01F 35/214

(57) ABSTRACT

A bubble forming device (500) according to an embodiment, a bubble growing nozzle (100) has a tip portion (110) to be disposed in a liquid (LQ) to grow a bubble (BS) at the tip portion (110). A large-bubble holding member (300) holds a large bubble (BL) at a position facing the tip portion (110) of the bubble growing nozzle (100) in the liquid (LQ), the large bubble (BL) being larger than the bubble (BS). By an attraction force (AF) due to a hydrophobic interaction between the bubble (BS) at the tip portion (110) of the bubble growing nozzle (100) and the large bubble (BL) held by the large-bubble holding member (300), the bubble (BS) is detached from the tip portion (110) of the bubble growing nozzle (100) and the detached bubble BS is released into the liquid (LQ).

### TECHNICAL FIELD

The present disclosure relates to a bubble forming device, a bubble forming method, an evaluation device, and an evaluation method.

### BACKGROUND ART

As disclosed in Patent Literature 1, a bubble forming device including a nozzle having a tip portion placed in a liquid and a pump that supplies gas to the nozzle is known. The nozzle discharges the gas supplied from the pump into the liquid as bubbles.

### CITATION LIST

### Patent Literature

Patent Literature 1: Unexamined Japanese Patent Application Publication No. S62-94159

### SUMMARY OF INVENTION

### Technical Problem

In the conventional bubble forming device, relatively high-pressure gas is supplied from the pump to the nozzle, and the liquid is agitated by the discharge of bubbles from the nozzle. In such a configuration, contamination is likely to occur and spread. Also, during the time till bubbles detach from the tip of the nozzle and after the bubbles are released into the liquid, the agitation of the liquid promotes dissolution of the bubbles, which makes it difficult to accurately grasp the characteristics and features of the bubbles formed in the liquid. Under these circumstances, there are situations where bubbles are desirably formed without using high pressure.

With the reduced pressure of the gas supplied to the nozzle, the diffusion of contamination caused by the agitation of the liquid can be suppressed. However, in that case, bubbles need to be grown until sufficient buoyance force acts on the bubbles to cause the bubbles to detach from the tip of the nozzle. This makes it difficult to form fine bubbles.

An objective of the present disclosure is to provide a technique that enables forming of fine bubbles without need of high pressure.

### Solution to Problem

A bubble forming device according to the present disclosure includes:
a bubble growing nozzle with at least a tip portion to be disposed into a liquid stored in a liquid tank to grow a bubble at the tip portion; and
a large-bubble holding member to hold a large bubble at a position facing the tip portion of the bubble growing nozzle in the liquid, the large bubble being larger than the bubble, wherein
by an attraction force due to a hydrophobic interaction between the bubble at the tip portion of the bubble growing nozzle and the large bubble held by the large-bubble holding member, the bubble is detached from the tip portion of the bubble growing nozzle and the detached bubble is released into the liquid.

A bubble growing step in which the bubble grows at the tip portion of the bubble growing nozzle and a bubble releasing step in which the grown bubble is detached from the tip portion by the attraction force and released into the liquid may be repeated continuously.

In a process in which the bubble growing step and the bubble releasing step are repeated, coalescence, in which the bubble detached from the tip portion after growing in the bubble growing step is absorbed in the large bubble without being released into the liquid, may occur intermittently.

The bubble forming device according to the present disclosure further includes a vibrator to vibrate the large bubble through the large-bubble holding member.

A bubble forming method according to the present disclosure includes:
a bubble growing step of growing a bubble at a tip portion of a bubble growing nozzle with at least the tip portion disposed in a liquid; and
a bubble releasing step of detaching the bubble grown in the bubble growing step from the tip portion of the bubble growing nozzle and releasing the detached bubble into the liquid by an attraction force due to a hydrophobic interaction between the bubble and a large bubble held at a position facing the bubble.

An evaluation device according to the present disclosure includes:
the aforementioned bubble forming device according to the present disclosure;
an imaging device to image how the bubble detached from the tip portion of the bubble growing nozzle and released into the liquid moves in the liquid; and
an analysis device to calculate an evaluation value representing at least one of ease of dissolution of the bubble into the liquid or ease of movement of the bubble in the liquid, using a physical quantity obtained from a result of imaging by the imaging device.

An evaluation method according to the present disclosure is an evaluation method using the aforementioned bubble forming device according to the present disclosure, the evaluation method including:
an imaging step of imaging how the bubble detached from the tip portion of the bubble growing nozzle and released into the liquid moves in the liquid; and
an analysis step of calculating an evaluation value representing at least one of ease of dissolution of the bubble into the liquid or ease of movement of the bubble in the liquid, using a physical quantity obtained from a result of imaging in the imaging step.

### Advantageous Effects of Invention

According to the bubble forming device and the bubble forming method according to the present disclosure, bubbles at the tip portion of the bubble growing nozzle are detached by the attraction force due to the hydrophobic interaction, thereby enabling formation of fine bubbles without need for high pressure.

### BRIEF DESCRIPTION OF DRAWINGS

FIG. 1 is a schematic diagram illustrating a configuration of a bubble forming device according to Embodiment 1;

FIG. 2 is a schematic diagram illustrating an enlarged main part of the bubble forming device according to Embodiment 1;

FIG. 3 is a flowchart illustrating an operation of the bubble forming device according to Embodiment 1;

FIG. 4 is a schematic diagram illustrating an enlarged main part of a bubble forming device according to Embodiment 2;

FIG. 5 is a schematic diagram illustrating a configuration of a bubble forming device according to Embodiment 3;

FIG. 6 is a graph illustrating dependence of a diameter of a bubble detached from a bubble forming nozzle on a distance between the bubble growing nozzle and a large bubble;

FIG. 7 is a schematic diagram illustrating a configuration of an evaluation device according to Embodiment 4; and

FIG. 8 is a schematic diagram illustrating an enlarged main part of a bubble forming device according to a modified example.

### DESCRIPTION OF EMBODIMENTS

Embodiments 1 to 4 are hereinafter described with reference to the drawings. In the drawings, same reference signs denote the same or corresponding components.

### Embodiment 1

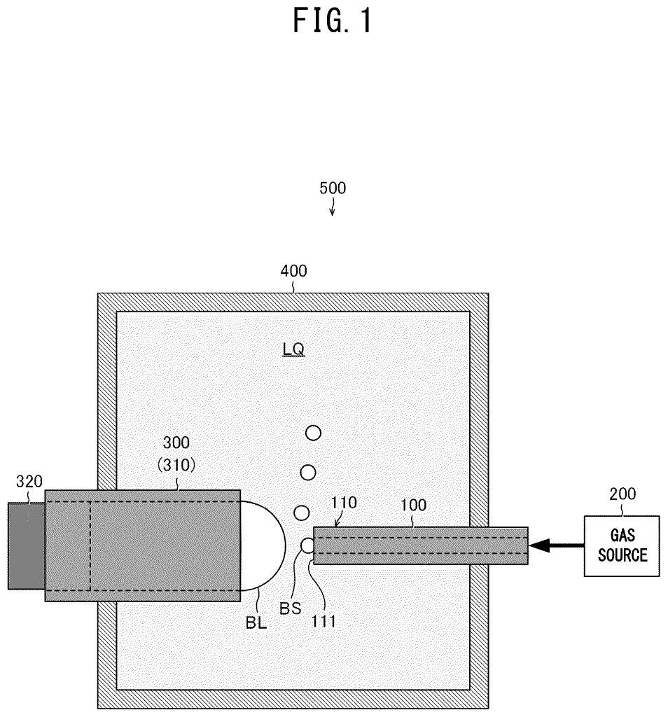

As illustrated in FIG. 1, a bubble forming device 500 according to the present embodiment includes a liquid tank 400 in which liquid LQ is stored, a bubble growing nozzle 100 with a tip portion 110 disposed in the liquid LQ in the liquid tank 400, a gas source 200 to supply gas to the bubble growing nozzle 100, and a large-bubble holding member 300 disposed at a position facing the tip portion 110 of the bubble growing nozzle 100.

The bubble growing nozzle 100 forms a hollow tubular member. The gas source 200 supplies gas to the bubble growing nozzle 100 from a rear end portion of the gas source 200 that is opposite the tip portion 110 in the length direction of the bubble growing nozzle 100. The bubble growing nozzle 100 thereby grow bubbles BS at the tip portion 110.

The large-bubble holding member 300 holds the large bubble BL, which is larger than the bubble BS, at a position facing the tip portion 110 of the bubble growing nozzle 100 in the liquid LQ. In the present embodiment, the large-bubble holding member 300 includes a syringe 310 and a pusher 320 that fits into the syringe 310.

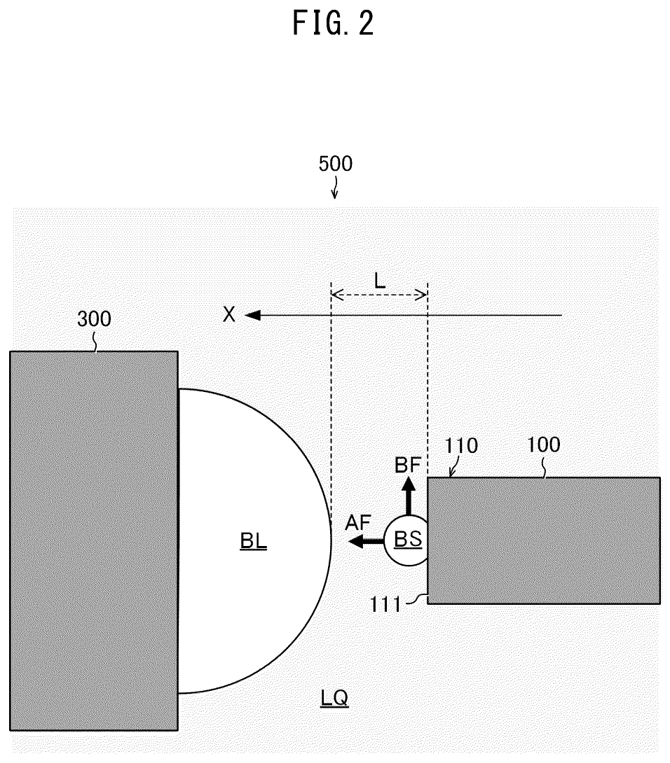

Action of the bubble forming device 500 according to the present embodiment is described with reference to FIG. 2. For the purpose of the following description, the X axis parallel to the length direction of the bubble growing nozzle 100 is defined. In the present embodiment, the X-axis direction coincides with the horizontal direction.

The large-bubble holding member 300 maintains the size of the large bubble BL constant. That is, the volume of the large bubble BL is constant. In the present embodiment, the large bubble BL remains stationary. A spacing L is maintained between the large bubble BL and an end surface 111 of the tip portion 110 of the bubble growing nozzle 100 that faces the large bubble BL. In the present embodiment, this spacing L is maintained constant.

The size of the bubble BS in the X-axis direction generated by the bubble growing nozzle 100 at the tip portion 110 is smaller than the spacing L. Thus, the liquid LQ exists between the bubble BS and the large bubble BL. However, an attraction force AF is generated between the bubble BS and the large bubble BL due to hydrophobic interaction therebetween.

The attraction force AF is greater as the distance between the bubble BS and the large bubble BL is smaller. Thus, when the size of the growing bubble BS in the X-axis direction reaches a value less than the spacing L and gets close enough to the large bubble BL, the bubble BS is detached from the end surface 111 by the attraction force AF. The detached bubble BS is released into the liquid LQ.

As described above, in the present embodiment, the pressure of the gas fed into the bubble growing nozzle 100 does not cause the bubble BS to be ejected from the end surface 111. In the present embodiment, the pressure of the gas fed into the bubble growing nozzle 100 is sufficient to allow the bubble BS to continue growing while the bubble BS is held at the end surface 111. Thus, a large pressure is not required as the pressure of the gas fed into the bubble growing nozzle 100.

In the present embodiment, not only a buoyance force BF of the bubble BS itself, but also the attraction force AF attracting the bubble BS to the large bubble BL are used as the force to detach the bubble BS from the end surface 111. Without use of the attraction force AF, the bubble BS would need to be grown until the buoyance force BF is sufficient for the bubble BS to be detached from the end surface 111.

By contrast, in the present embodiment, by also using the attraction force AF, the bubble BS can be detached from the end surface 111 at a stage when the bubble BS has not grown so much. This enables formation of fine bubbles BS. For example, according to the present embodiment, the bubbles BS with a diameter of less than 300 μm, more specifically, so-called fine bubbles with a diameter of less than 100 μm can be formed.

The end surface 111 of the bubble growing nozzle 100 preferably undergoes a wetting improvement treatment to enhance wettability to the liquid LQ. The term “wettability” here is synonymous with “hydrophilicity” when the liquid LQ is water.

Specifically, the surface layer of the end surface 111 of the bubble growing nozzle 100 is preferably composed of a film with higher wettability than other parts of the bubble growing nozzle 100. When the liquid LQ is water, such a film can be composed of, for example, titanium dioxide, silicone, etc.

When the end surface 111 of the bubble growing nozzle 100 undergoes a wetting improvement treatment, the liquid LQ can easily enter the interface between the growing bubble BS and the end surface 111. This facilitates the release of the bubble BS from the end surface 111. Thus, the bubbles BS can be detached from the end surface 111 at a smaller size stage, thereby increasing the fineness of the bubbles BS.

According to the present embodiment, the size of the bubbles BS to be released into the liquid LQ is easily adjustable. That is, since the magnitude of the attraction force AF depends on the distance between the bubble BS and the large bubble BL, the size of the bubble BS when detaching from the end surface 111 is adjustable by the spacing L. Specifically, the smaller spacing L, the more the bubbles BS at the smaller size stage can be detached from the end surface 111.

On the other hand, in the present embodiment, the spacing L is maintained constant in the process of repeatedly detaching the bubbles BS from the end surface 111. Thus, the size of the bubbles BS when detaching from the end surface 111 can be maintained almost constant. That is, diameter variation among the bubbles BS is reduced. However, the spacing L may be adjusted dynamically in the process of repeatedly detaching the bubbles BS from the end surface 111.

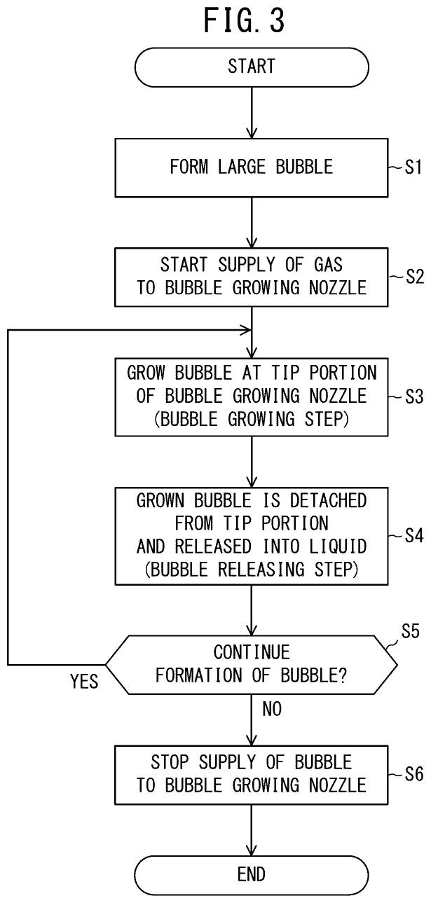

The operation of the bubble forming device 500 according to the present embodiment is described with reference to FIG. 3.

As illustrated in FIG. 3, firstly, the large bubble BL is formed (step S1). Specifically, by pushing the pusher 320 into the syringe 310, a hemispherical large bubble BL is formed at the end portion of the syringe 310 that faces the bubble growing nozzle 100. At the time when the large bubble BL is formed, the pusher 320 is brought to rest. With the syringe 310 holding the large bubble BL in this way, the following steps S2 to S6 are performed.

Next, supply of gas from the gas source 200 to the bubble growing nozzle 100 is started (step S2). Then the bubble BS grows at the tip portion 110 of the bubble growing nozzle 100 (step S3). Step S3 is a bubble growing step in which the bubble BS grows.

Then, when the bubble BS grows to a certain size, that is, the distance between the bubble BS and the large bubble BL reaches a threshold, the bubble BS is detached from the end surface 111 by the attraction force AF and released into the liquid LQ (step S4). Step S4 is a bubble releasing step in which the bubble BS is released into the liquid LQ.

Next, when the formation of the bubbles BS continues (Yes in step S5), the process returns to step S3. In this way, while gas is continuously supplied from the gas source 200 to the bubble growing nozzle 100, the bubble growing step of step S3 and the bubble releasing step of step S4 are continuously repeated. That is, according to the present embodiment, the bubbles BS can be continuously formed one by one.

When the formation of the bubbles BS is stopped (No in step S5), supply of gas from the gas source 200 to the bubble growing nozzle 100 is stopped (step S6). In this way, the formation of the bubbles BS can be stopped at a desired timing.

Each operation of the aforementioned step S1, S2, and S6 and the determination in step S5 may be made by a user or automatically performed by non-illustrated control means.

### Example A

Using the bubble forming device 500 illustrated in FIG. 1, bubbles BS were formed. Nitrogen gas was used as the gas constituting the bubbles BS. Air was used for the gas constituting the large bubble BL. Purified water was used for the liquid LQ. For the bubble growing nozzle 100, a hollow tubular body with an inner diameter of 7 μm and an outer diameter of 1.5 mm was used. For the syringe 310 of the large-bubble holding member 300, a hollow tubular body with an inner diameter of 2 mm and an outer diameter of 3 mm was used.

The dependence of the size of the bubble BS on the spacing L was examined while the size of the large bubble BL and the pressure of the gas fed into the bubble growing nozzle 100 were maintained constant.

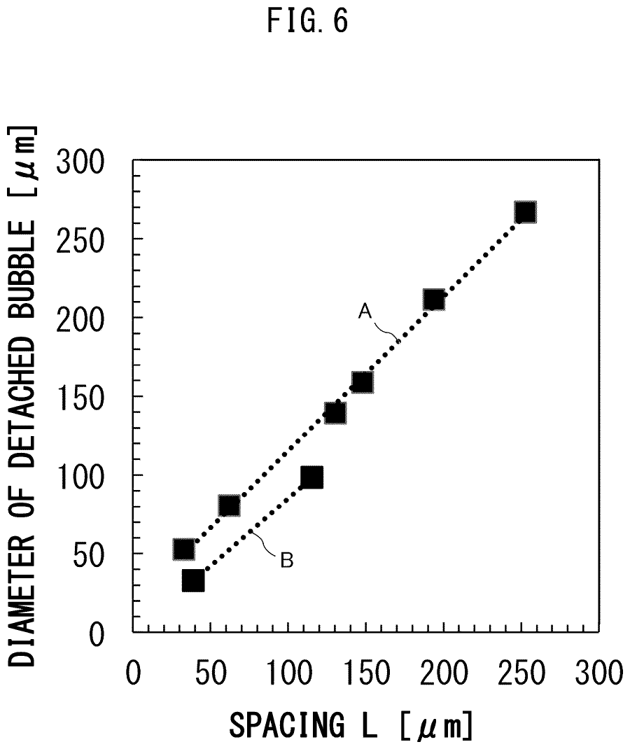

The graph A of FIG. 6 shows the results of Example A. The horizontal axis in FIG. 6 shows the spacing L, and the vertical axis shows the diameter of the bubble BS when detaching the end surface 111.

As a comparative example, bubbles BS were formed under the same conditions as in Example A, except that the large bubble BL was not provided. As a result, in the comparative example in without the large bubble BL, the diameter of the bubble BS when detaching from the end surface 111 of the bubble growing nozzle 100 was about 300 μm.

By contrast, as shown in graph A in FIG. 6, the diameter of the bubble BS formed in Example A was less than 300 μm. This confirmed that use of the attraction force AF by the large bubble BL can form finer bubble BS than otherwise.

Graph A of FIG. 6 confirmed that the smaller bubble BS can be formed at the smaller spacing L. Also, the diameter of the bubble BS was found to be approximately proportional to the spacing L. Thus, the diameter of the bubble BS is easily adjustable depending on the spacing L.

### Embodiment 2

Embodiment 1 exemplifies the conditions in which coalescence between the bubble BS and the large bubble BL does not occur. The bubble may be formed under the conditions in which coalescence between the bubble BS and the large bubble BL can occur intermittently. Hereinafter, a specific example is described.

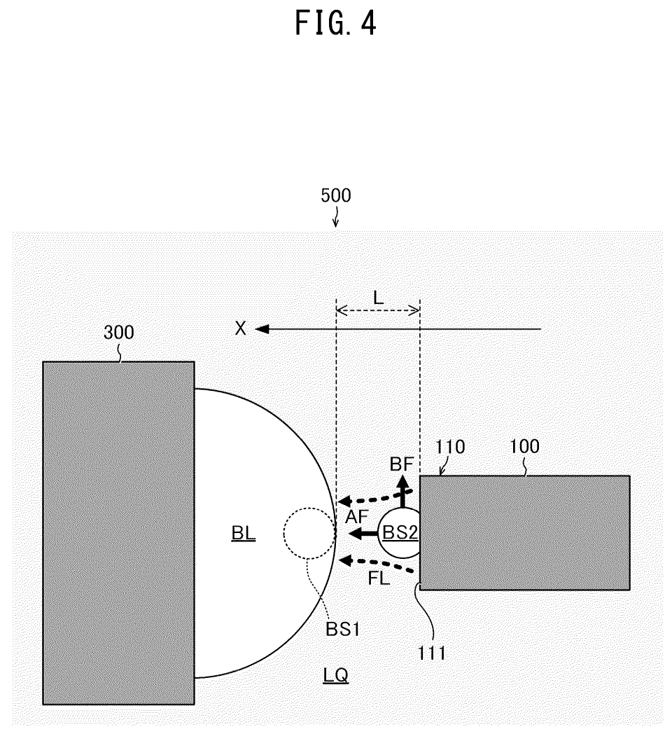

The configuration and action of the present embodiment are described with reference to FIG. 4. In the present embodiment, the conditions, such as spacing L, are adjusted so that the coalescence between the bubble BS and the large bubble BL can occur. Here, the term “coalescence” refers to the bubble BS detached from the end surface 111 due to the attraction force AF being absorbed in the large bubble BL without being released in the liquid LQ.

FIG. 4 illustrates a bubble BS1 having coalesced into the large bubble BL. When the bubble BSI coalesces into the large bubble BL, the movement of the bubble BS1 creates a local flow FL of the liquid LQ from the end surface 111 to the large bubble BL. FIG. 4 illustrates the local flow FL as a dashed line.

In addition to the attraction force AF, this local flow FL can also be used for a bubble BS2 grown following the bubble BSI to be vigorously detached from the end surface 111. The bubble BS2 is released into the liquid LQ without coalescence into the large bubble BL.

In comparison with the case of Embodiment 1, the bubble BS2 vigorously detaches from the end surface 111 of the bubble BS2, this detachment of the bubble BS2 also creates a local flow FL. In this way, once the bubble BSI coalesces into the large bubble BL, use of attraction force AF as well as the local flow FL can detach the bubbles BS from the end surface 111 one after another.

However, even after the coalescence between the bubble BSI and the large bubble BL, coalescence between another BS and the large bubble BL occurs probabilistically. That is, in the present embodiment, the spacing L is maintained constant, but the coalescence in which the bubble BS is absorbed in the large bubble BL occurs intermittently in the process of repeating the bubble growing step and the bubble releasing step.

As described above, in the present embodiment, use of the attraction force AF as well as the local flow FL can detach the bubbles BS from the end surface 111 on after another. This enables formation of finer bubbles BS than in Embodiment 1.

### Example B

Using the same bubble forming device 500 used in Example A described above, the bubble BS was formed under the conditions in which coalescence between the bubble BS and the large bubble BL occurs intermittently. That is, the spacing L, pressure of gas to be fed to the bubble growing nozzle 100, and the like were adjusted so that the coalescence between the bubble BS and the large bubble BL occurs intermittently.

The graph B of FIG. 6 shows the results of Example B. In each case where the spacing L was 98 μm and 33 μm, coalescence occurred intermittently. The fact that the graph B is positioned below the graph A in FIG. 6 confirms that use of not only the attraction force AF but also the local flow FL to detach the bubble BS from the end surface 111 can create finer bubble BS.

### Embodiment 3

In the above Embodiments 1 and 2, the large bubble BL may be vibrated in the liquid LQ. Hereinafter, a specific example is described.

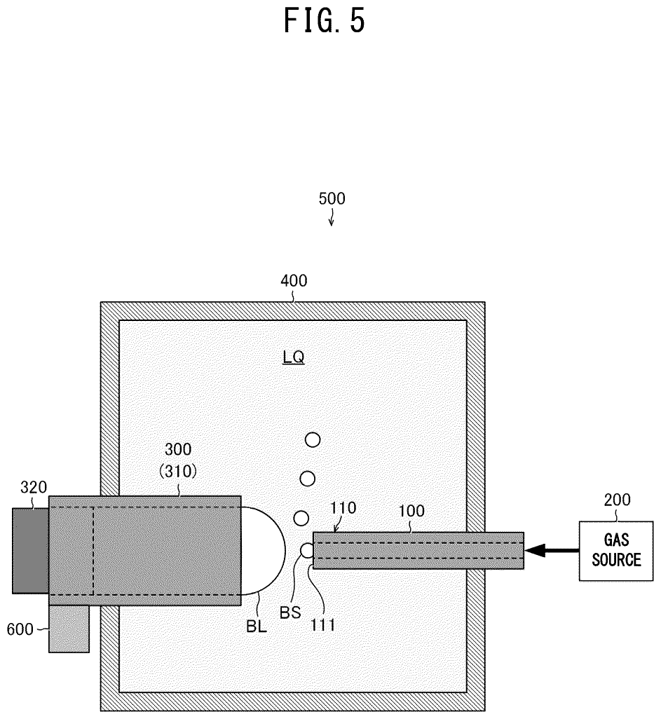

As illustrated in FIG. 5, a bubble forming device 500 according to the present embodiment further includes a vibrator 600 to vibrate the large-bubble holding member 300. The vibrator 600 is fixed to the large-bubble holding member 300 outside the liquid tank 400.

The vibrator 600 vibrates the large bubble BL in the liquid LQ through the large-bubble holding member 300. The frequency of the vibration is preferably, for example, 200 Hz or more, and more preferably 300 Hz or more. In the present embodiment, a vibration of 410 Hz is applied to the large bubble BL. The large bubble BL vibrates, but the volume of the large bubble BL is constant.

According to the present embodiment, a vibratory flow of the liquid LQ is created between the large bubble BL and the end surface 111 of the bubble growing nozzle 100 as the large bubble BL vibrates. The vibratory flow of the liquid LQ promotes the detachment of the bubble BS from the end surface 111. This can increase the fineness of the bubbles BS.

### Embodiment 4

The bubble forming device 500 according to Embodiments 1 to 3 described above can be applied to a technique of evaluating dissolution characteristics or the like of the bubble BS into the liquid LQ. Hereinafter, a specific example is described.

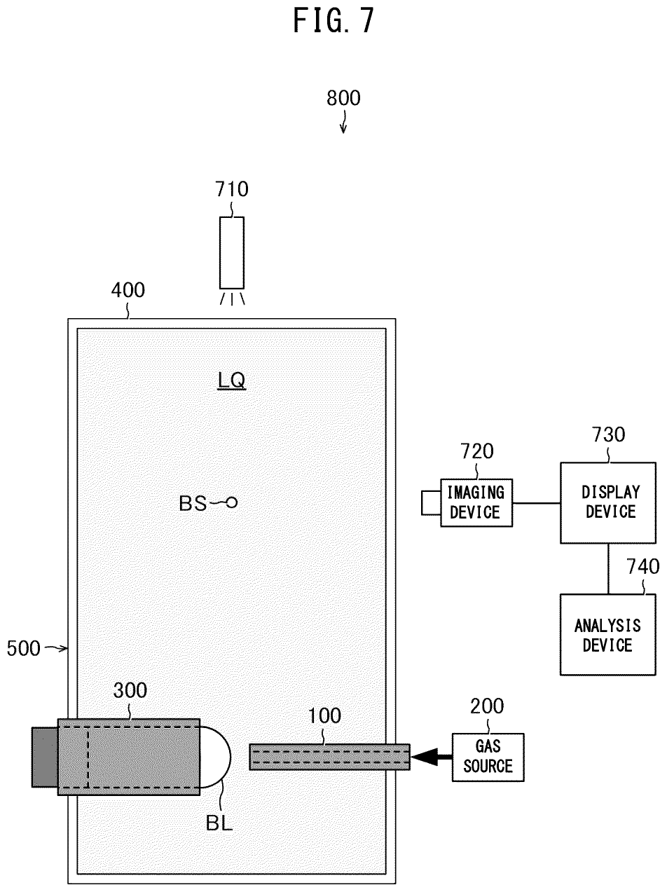

As illustrated in FIG. 7, an evaluation device 800 according to the present embodiment includes the bubble forming device 500 described above, a light irradiator 710 that irradiates with light the bubble BS released into the liquid LQ by the bubble forming device 500, an imaging device 720 that images the bubble BS irradiated with light, a display device 730 that displays a result of the imaging by the imaging device 720, and an analysis device 740 that analyzes a physical quantity read from the display on the display device 730.

The light irradiator 710 irradiates the bubble BS with light to allow the bubble BS to be clearly imaged by the imaging device 720. The imaging device 720 includes a video camera. The frame rate of the video camera is, for example, 10000 fps or higher. The display device 730 and the analysis device 740 are configured by a personal computer.

The operation of the evaluation device 800 according to the present embodiment is described.

First, the bubble BS is released into the liquid LQ by the bubble forming device 500. Next, while the bubble BS is irradiated by the light irradiator 710, how the bubble BS moves in the liquid LQ is captured as a moving image by the imaging device 720 (imaging step). The moving image captured by the imaging device 720 is displayed on the display device 730.

In the present embodiment, a user determines one or more physical quantities based on display on the display device 730. Specifically, the physical quantities can be read from a display screen of the display device 730.

Here, the term “physical quantity” refers to a value that depends on at least one of ease of dissolution of the bubble BS into the liquid LQ or ease of movements of the bubble BS in the liquid LQ. Specifically, at least one selected from a group including a diameter of the bubble BS, a rate of time variation of a diameter of the bubble BS, a rate of movement of the bubble BS, and the like is exemplified as a physical quantity. The physical quantity may be one or more.

Then the user enters in the analysis device 740 the physical quantity read from the display of the display device 730. The user may enter in the analysis device 740 time-series data representing time variation of the one or more physical quantities. The analysis device 740 uses the entered physical quantity to calculate an evaluation value representing at least one of the ease of dissolution of the bubble BS into the liquid LQ or ease of movement of the bubble BS in the liquid LQ (analysis step). Here, specifically, a mass transfer coefficient is exemplified as an evaluation value.

In the present embodiment, the following effect can be obtained.

The bubble forming device 500 enables the bubble BS to be positioned in the static liquid LQ with little disturbance of the liquid LQ in the liquid tank 400, except in the local area between the bubble growing nozzle 100 and the large-bubble holding member 300. Thus, the physical quantity determined based on the result of imaging by the imaging device 720 and the evaluation value calculated by the analysis device 740 are less susceptible to errors caused by the disturbance of the liquid LQ.

That is, if there is disturbance in the liquid LQ, the disturbance affects the ease of dissolution of the bubble BS into the liquid LQ and ease of the movement of the bubble BS in the liquid LQ. By contrast, the present embodiment enables evaluation with high accuracy of ease of dissolution of the bubble BS into the liquid LQ and ease of the movement of the bubble BS in the liquid LQ without being affected significantly by the disturbance of the liquid LQ.

The bubble forming device 500 also enables formation of the bubble BS without need for high pressure, thereby reducing the likelihood of contamination occurring and spreading in the liquid LQ. This also contributes to improving evaluation accuracy.

The bubble forming device 500 also enables only one bubble BS to be released into the liquid LQ on demand, that is, at a desired timing, or a plurality of bubbles BS to be released into the liquid LQ one after another. In the latter case, a repetitive period of releasing the bubbles BS can be adjusted by the spacing L illustrated in FIG. 2, pressure of gas to be fed into the bubble growing nozzle 100, and the like. With the vibrator 600 illustrated in FIG. 5, a plurality of bubbles BS can be positioned in the liquid LQ in a disposed state. In this way, the bubbles BS can be positioned in the liquid LQ in various forms, thereby achieving easy evaluation on the bubbles BS in the various forms.

The bubbles BS have characteristics of adsorbing and floating suspended substances in the liquid LQ, that is, adsorption separation characteristics. Predicting or controlling behaviors of the bubbles BS immediately after the occurrence of the bubbles BS about characteristics of dissolution of the bubbles BS into the liquid LQ, expansion characteristics of the bubbles BS based on the above evaluation value is useful for making the bubbles BS exhibit appropriate adsorption separation characteristics. The control of the behaviors of the bubbles BS may be conducted considering the size of the above suspended substances, a zeta potential, and the like.

Since the characteristics of dissolution of the babbles BS into the liquid LQ can be known based on the evaluation value, reaction characteristics of the bubbles BS in the liquid LQ can also be predicted or evaluated based on the dissolution characteristics.

The dispersion stability representing a duration of lifetime of the bubbles BS floating in the liquid LQ can also be known based on the above evaluation value, a concentration of dissolved gases around the bubbles BS, the zeta potential, and the like.

Recently, use of fine bubbles BS with a diameter of 100 μm or less generated in the liquid LQ has been advancing in the fields such as chemical and biological industries. To commercialize and industrialize products using fine bubbles BS, it is important to obtain reproducibility and evidence of experiments based on the characteristics and the features of the bubbles BS. As described above, the evaluation device 800 according to the present embodiment enables quantitative evaluation of the dissolution characteristics, the adsorption separation characteristics, the reaction characteristics, and the dispersion stability of the bubbles BS. This enables design and manufacture of the bubble forming devices 500 suitable for each application. For example, in the fields such as chemical and biological industries, use of such a bubble generation device 500 can significantly contribute to shortening the reaction time of chemical and enzymatic reactions and more efficiently performing various cell cultures.

In the present embodiment, the user is assumed to read the physical quantity from the display on the display device 730, but image analysis techniques may be used for the reading. Also, a computer may automatically determine the physical quantity based on the result of the imaging by the imaging device 720 using image analysis. and the like and automatically provide the determined physical quantity to the analysis device 740. In that case, the display device 730 is not essential.

Embodiments 1 to 4 are described above. Modifications described below can also be made.

FIG. 2 exemplifies the configuration in which the X-axis direction that is the length direction of the bubble growing nozzle 100 coincides with the horizontal direction. The X-axis direction does not necessarily have to coincide with the horizontal direction. The X-axis direction may have an inclination angle θ in a range of −90° to 90° with respect to the horizontal direction. Also, if the large bubble BL is held at a position facing the bubble BS at the tip portion 110 of the bubble growing nozzle 100, the length direction of the large-bubble holding member 300 does not necessarily have to coincide with the X-axis direction.

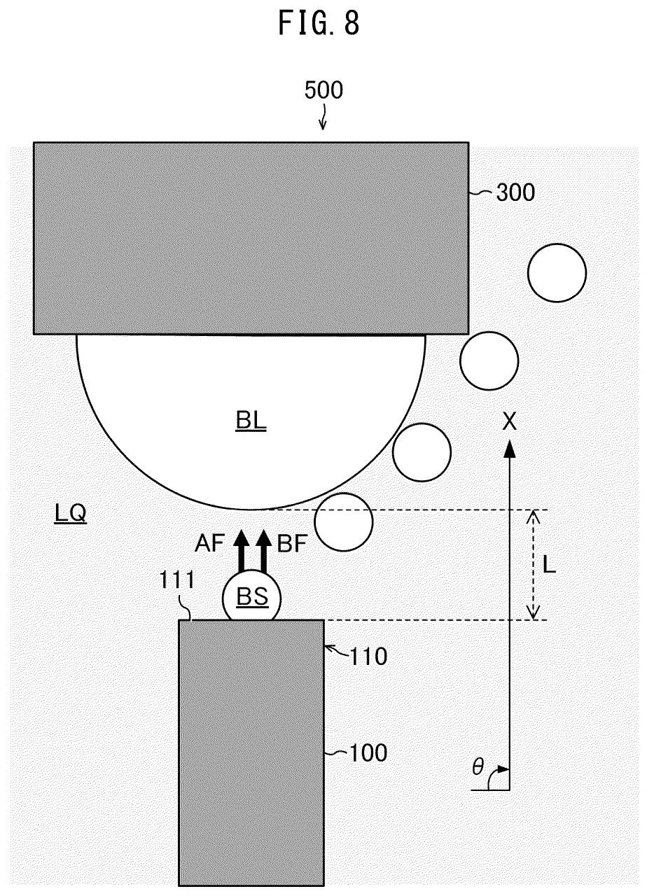

FIG. 8 illustrates a modified example in which the bubble growing nozzle 100 is arranged vertically upward. That is, in this modified example, the bubble growing nozzle 100 is inclined by an inclination angle θ of 90° with respect to the horizontal direction. According to this modified example, the direction of the attraction force AF can be made to coincide with the direction of the buoyance force BF.

FIG. 1 exemplifies the large-bubble holding member 300 including the syringe 310 and the pusher 320, but the configuration of the large-bubble holding member 300 is not limited to this configuration. The large-bubble holding member 300 may be configured by a bottomed cylindrical body, or may be configured by a hollow tubular body and a gas source for large bubble that supplies gas constituting the large bubble BL to the hollow tubular body, similarly to the bubble growing nozzle 100 and the gas source 200.

FIG. 5 exemplifies the vibrator 600 that vibrates the syringe 310 of the large-bubble holding member 300, but the configuration of the vibrator 600 is not limited to this configuration. The vibrator 600 may be any vibrator that vibrates the large bubble BL through the large-bubble holding member 300. For example, the vibrator 600 may vibrate the large bubble BL through the vibration of the internal pressure of the large bubble BL by vibrating the pusher 320.

FIG. 2 exemplifies a configuration in which the spacing L is maintained constant in the process of repeating the bubble growing step and the bubble releasing step, but the spacing L may be varied in the process of repeating the bubble growing step and the bubble releasing step. For example, the spacing L may be varied periodically in the process of repeating the bubble growing step and the bubble releasing step.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2022-107754, filed on Jul. 4, 2022, including the specification, claims, drawings, and abstract, the entire disclosure of which is incorporated by reference herein.

### REFERENCE SIGNS LIST

100 Bubble growing nozzle
110 Tip portion
111 End surface
200 Gas source
300 Large-bubble holding member
310 Syringe
320 Pusher
400 Liquid tank
500 Bubble forming device
600 Vibrator
710 Light irradiator
720 Imaging device
730 Display device
740 Analysis device
800 Evaluation device
LQ Liquid
BS Bubble
BL Large bubble
FL Local flow

1. A bubble forming device, comprising:
a bubble growing nozzle with at least a tip portion to be disposed into a liquid stored in a liquid tank to grow a bubble at the tip portion; and
a large-bubble holding member to hold a large bubble at a position facing the tip portion of the bubble growing nozzle in the liquid, the large bubble being larger than the bubble, wherein
by an attraction force due to a hydrophobic interaction between the bubble at the tip portion of the bubble growing nozzle and the large bubble held by the large-bubble holding member, the bubble is detached from the tip portion of the bubble growing nozzle and the detached bubble is released into the liquid.

2. The bubble forming device according to claim 1, wherein
a bubble growing in which the bubble grows at the tip portion of the bubble growing nozzle and a bubble releasing in which the grown bubble is detached from the tip portion by the attraction force and released into the liquid are repeated continuously.

3. The bubble forming device according to claim 2, wherein
in a process in which the bubble growing and the bubble releasing are repeated, coalescence in which the bubble detached from the tip portion after growing in the bubble growing is absorbed in the large bubble without being released into the liquid occurs intermittently.

4. The bubble forming device according to claim 1, further comprising:
a vibrator to vibrate the large bubble through the large-bubble holding member.

5. A bubble forming method, comprising:
growing a bubble at a tip portion of a bubble growing nozzle with at least the tip portion disposed in a liquid; and
detaching the grown bubble grown in the bubble from the tip portion of the bubble growing nozzle and releasing the detached bubble into the liquid by an attraction force due to a hydrophobic interaction between the bubble and a large bubble held at a position facing the bubble.

6. An evaluation device, comprising:
the bubble forming device according to claim 1;
an imaging device to image how the bubble detached from the tip portion of the bubble growing nozzle and released into the liquid moves in the liquid; and
an analysis device to calculate an evaluation value representing at least one of ease of dissolution of the bubble into the liquid or ease of movement of the bubble in the liquid, using a physical quantity obtained from a result of imaging by the imaging device.

7. An evaluation method using the bubble forming device according to claim 1, the evaluation method comprising:
imaging how the bubble detached from the tip portion of the bubble growing nozzle and released into the liquid moves in the liquid; and
calculating an evaluation value representing at least one of ease of dissolution of the bubble into the liquid or ease of movement of the bubble in the liquid, using a physical quantity obtained from a result of the imaging.
